(19) United States
(12) Patent Application Publication
(10) Pub. No.: US 2017/0373546 A1
(43) Pub. Date: Dec. 28, 2017

(54) ELECTRIC MACHINE DESIGNED TO LIMIT SOUND NUISANCE

(71) Applicant: Valeo Systemes de Controle Moteur, Cergy Saint Christophe (FR)

(72) Inventors: François Machet, Poissy (FR); Patrick Lebrasseur, Montagny En Vexin (FR)

(73) Assignee: Valeo Systemes de Controle Moteur, Cergy Saint Christophe (FR)

(21) Appl. No.: 15/519,986

(22) PCT Filed: Oct. 19, 2015
(86) PCT No.: PCT/FR2015/052798

§ 371 Date: Aug. 15, 2017

(30) Foreign Application Priority Data
Oct. 20, 2014 (FR) 1460049

(51) Int. Cl. H02K 1/18; H02K 21/12; H02K 1/27

(52) U.S. Cl. CPC H02K 1/185; H02K 1/27; H02K 21/12

(57) ABSTRACT

The invention relates to an electric machine (1) comprising at least one stator (2), the stator being formed by a body (21) and teeth (22) arranged on the inner face (221) of the body (21) of the stator (2), the stator (2) comprising at least one inner recess (24) formed in the body (21) of the stator (2), of any geometric shape allowing the mechanical stresses on the stator (2) to be limited.

This invention relates to the field of electric machines and relates more particularly to electric machines comprising at least one stator.

An electric machine is a machine, also called a motor, which comprises at least one stator. The stator comprises teeth forming coils. Powering each of the coils creates a magnetic field within the stator, with a rotor orienting itself along the field lines.

In the field of motor vehicles, these electric machines are used, for example, in electrical systems such as supercharged electric compressors.

For example, these machines are used in the induction system in order to improve the vehicle's performance, to compensate for the lag time of a conventional turbocharger on start-up, or during the vehicle's transient phases.

However, this type of machine is a source of noise. In fact, the electromagnetic forces created on the stator and rotor cause high-frequency micro-displacements within the audible range of the human ear, between 1,000 and 20,000 Hz. The vibrations are transmitted along the entire structure of the machine and spread through the air and into the machine's supports. Although the noises driven by the machine towards the support can be reduced by dampers, the intrinsic noises of the machine are more difficult to deal with.

One solution to this noise involves reducing the effects of the radial forces. The effects of the radial forces are reduced, for example, by creating recesses in the material on the external face of the stator, in the extension of the stator teeth. This solution enables a gain in deformation, allowing the radial forces on the part in contact with the stator to be reduced by 10%. This gain helps partially to reduce the noise but it still remains audible to the human ear.

The aim of this invention is therefore to overcome one or more of the drawbacks of machines of the prior art by proposing an electric machine configured so as to limit sound nuisance.

For this reason, the present invention proposes an electric machine comprising at least one stator, the stator being formed by a body and teeth arranged on the inner face of the body of the stator, characterized in that the stator comprises at least one internal recess formed in the body of the stator.

In fact, it is the mechanical stress that contributes to sound nuisance by promoting radial forces. Reducing the effects of radial forces via recesses thus limits sound nuisance.

According to an embodiment of the invention, the recess extends longitudinally in the stator body parallel to a longitudinal axis of the stator.

According to an embodiment of the invention, the internal recess has any geometric form capable of limiting the mechanical stress on the stator.

According to an embodiment of the invention, the width of the internal recess is less than the width of a stator tooth.

According to an embodiment of the invention, the internal recess is a cylinder or an ellipse.

According to an embodiment of the invention, the width of the internal recess is arranged in the axis of a stator tooth.

According to an embodiment of the invention, the internal recess is formed in the stator body at a sufficient distance from an internal face 221 of the stator body so as not to disturb the magnetic field.

According to an embodiment of the invention, the stator comprises at least two external recesses formed on the external face of the stator.

According to an embodiment of the invention, the external recess forms a groove oriented longitudinally along the longitudinal axis of the stator.

According to an embodiment of the invention, the external recess 25 is centered between two internal recesses 24 and overlaps, at each of its sides, an internal recess 24.

The invention also relates to the use of the electric machine according to the invention in an electric supercharger for a motor vehicle.

The invention also concerns an electric supercharger equipped with an electric machine according to the invention.

Further aims, features and advantages of the invention will emerge more clearly from the following description with reference to the accompanying figures, given by way of example, in which:

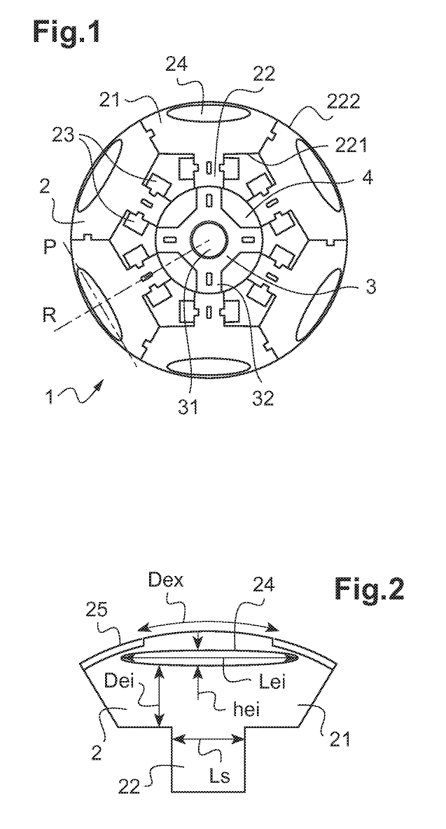

FIG. 1 is a schematic representation of a cross-sectional view of a device according to the invention,

FIG. 2 is a schematic representation of a detail of a device according to the invention.

This invention relates to an electric machine 1. The electric machine 1 comprises at least one stator 2, shown in FIGS. 1 and 2. The electric machine also comprises a rotor 3 arranged inside the stator 2. More precisely, the rotor 3 is arranged in a space 4 formed at the center of the stator 2.

According to an embodiment of the invention, the electric machine is a direct- or alternating-current, synchronous or asynchronous machine or any type of electric machine of the same type.

According to an embodiment of the invention, the electric motor is a Switched Reluctance Motor (SRM).

According to an embodiment of the invention, the stator comprises a body formed by a stack of thin sheets forming a ring, also called a laminated core, the internal face of which is provided with recesses open to the interior to receive the phase windings that form a coil.

According to an embodiment of the invention, the rotor has permanent magnets.

The stator 2 is formed of at least one body 21. According to an embodiment of the invention, the stator is formed of several bodies. The stator is also formed of several teeth 22. The teeth 22 are arranged on the inner face 221 of the stator body delimiting the space 4 in which the rotor is located. The stator 2 comprises n teeth 22, n being between 4 and 12, and very preferably 6. Around each tooth 22 a winding is arranged that thus forms the coils 23 of the stator. The supply of each of these coils 23 allows a magnetic field to be created in the stator 2.

According to an embodiment of the invention, the rotor 3 comprises rotor teeth 32 oriented along the field lines of the stator 2. The number of teeth of the rotor 3 ranges between 2 and 8, and preferably 4.

Within the scope of the invention, the stator 2 comprises at least one internal recess 24. This internal recess 24 is formed in the actual body 21 of the stator. The internal recess 24 is formed in the body 21 of the stator 2 and extends longitudinally, along the longitudinal axis 31 of the stator, over at least part of the stator, into the body 21 of the stator 2. More precisely, the internal recess 24 extends parallel to the axis 31 of the stator.

Within the scope of the invention, the longitudinal axis 31 of the stator is defined as being the axis 31 along which the stator extends, passing through the center of the stator, namely the axis 31 around which the stator is arranged.

According to an embodiment of the invention, the internal recess 24 extends longitudinally along the entire length of the stator 2.

According to an embodiment of the invention, the width Lₑᵢ of the internal recess 24 is greater than the width Lₛ of a tooth 22 of the stator 2.

Within the scope of the invention, the width, of the recess and stator teeth, is defined by the magnitude oriented along a plane P perpendicular to a plane passing through the radius R of the stator, in contrast to the height, which is defined by the magnitude passing through the radius R of the stator. Within the scope of the invention, the internal recess 24 has any possible geometric form. More precisely, the internal recess 24 has any geometric form limiting the mechanical stress on the stator 2. In fact, it is the mechanical stress that contributes to sound nuisance by promoting radial forces. Reducing the effects of these forces thus limits sound nuisance.

According to an embodiment of the invention, the internal recess 24 is a cylinder whose generatrix has any form enabling the mechanical stress on the stator to be limited.

According to an embodiment of the invention, the internal recess 24 is round.

According to an embodiment of the invention, the internal recess 24 is oval, its width Lₑᵢ being greater than its height hₑᵢ.

According to an embodiment of the invention, the internal recess is square or rectangular. For example, the internal recess 24 is rectangular or square, with rounded corners.

According to an embodiment of the invention, the internal recess 24 is elliptical, more precisely the internal recess 24 is an elliptical cylinder whose width is greater than its height.

The internal recess 24 is arranged in the axis of a stator tooth 22. More precisely, the internal recess 24 is arranged in a part of the body 21 of the stator 2 extending a tooth 22 of the stator.

According to an embodiment, the internal recess 24 is formed in the stator body at a sufficient distance from the internal face 221 of the stator body so as not to disturb the magnetic field. More precisely, the shorter distance Dₑᵢ between an edge of the internal recess 24 and the internal face 221 of the stator body is greater or the same as the width of a stator tooth divided by two (Lₛ/2). Such an arrangement avoids changing the magnetic field of the electric machine.

According to an embodiment of the invention, the internal recess 24 is arranged in the body 21 of the stator 2 and on the periphery of the body 21. This means that the internal recess 24 is closer to the external face 222 of the stator 2 than the internal face 221 of the stator 2.

Within the scope of the invention, the external face 222 of the stator 2 is that which does not comprise a tooth 22 and that is arranged on the outside of the stator 2 if we consider that the internal face 221 of the stator delimits an area 4 of the stator 2 in which the rotor 3 is arranged.

According to an embodiment of the invention, the stator 2 comprises a number of recesses 24 identical to the number of teeth 22 of the stator. For example, if the stator comprises six teeth, the stator comprises six internal recesses 24.

According to a variation of the invention, the stator 2 comprises at least one external recess 25 formed on the external face of the stator, shown in FIG. 2.

This external recess 25 forms a groove oriented along the axis 31 of the rotor 3. The external recess 25 is offset in relation to the teeth 22 of the stator. The external recess 25 is centered between two internal recesses 24.

According to an embodiment of the invention, the width of the external recess 25 is such that it overlaps, at each of its sides, an internal recess 24.

According to an embodiment of the invention, the machine comprises two external recesses 25, the distance Dₑₓ between two external recesses 25 being less than the width Lₑᵢ of an internal recess 24. The stator 2 thus comprises an alternation of internal recesses 24 and external recesses 25. The depth of the external recess 25 is within 0 and a remaining thickness of the stator body greater than or equal to the width of a stator tooth divided by two (Lₛ/2). Within the scope of the invention, remaining thickness means the remaining thickness between the bottom of the recess and the internal face 221 of the stator or the start of a stator tooth 22.

According to an embodiment of the invention, the stator 2 comprises a number of external recesses 25 identical to the number of stator teeth 22. For example, if the stator comprises six teeth, the stator comprises six external recesses 25.

Such a stator 2 according to the invention enables a gain of 50% in terms of mechanical stress.

The invention also concerns the use of such a machine according to the invention in an electric supercharger for a motor vehicle.

The invention also concerns an electric supercharger equipped with such a machine 1 according to the invention. More precisely, the invention also relates to an electric compressor equipped with a switched reluctance motor according to the invention. This electric supercharger for a motor vehicle comprises a compressor wheel and an electric machine according to the invention, to drive the compressor wheel.

The scope of the present invention is not limited to the details given above and permits embodiments in numerous other specific forms without departing from the field of application of the invention. Consequently, the present embodiments must be considered as being by way of illustration and can be changed without, however, departing from the scope defined by the claims.

1. An electric machine comprising:
at least one stator, the stator being formed by a body and teeth arranged on the inner face of the body of the stator,
wherein the stator comprises at least one internal recess formed in the body of the stator.

2. The electric machine according to claim 1, wherein the internal recess extends longitudinally in the body of the stator parallel to a longitudinal axis of the stator.

3. The electric machine according to claim 1, wherein the width Lₑᵢ of the internal recess is less than the width Lₛ of a tooth of the stator.

4. The electric machine according to claim 1, wherein the internal recess is a cylinder or an ellipse.

5. The electric machine according to claim 1, wherein the internal recess is arranged in the axis of a tooth of the stator.

6. The electric machine according to claim 1, wherein the internal recess is formed in the body of the stator at a sufficient distance from an internal face of the body of the stator so as not to disturb the magnetic field.

7. The electric machine according to claim 1, wherein the stator comprises at least two external recesses formed on the external face of the stator.

8. The electric machine according to claim 7, wherein the external recess forms a groove oriented longitudinally along the longitudinal axis of the stator.

9. The electric machine according to claim 7, wherein the external recess is centered between two internal recesses and overlaps, at each of its sides, an internal recess.

10. The electric machine according to claim 1, wherein the electric machine is used in an electric supercharger for a motor vehicle.

11. An electric supercharger equipped with an electric machine according to claim 1.
